(19) United States
(12) Patent Application Publication
(10) Pub. No.: US 2015/0241610 A1
(43) Pub. Date: Aug. 27, 2015

(54) Increasing Visibility Of Machinery With Retroreflective Beads Embedded In A Coating

(71) Applicants: Zane McCarthy, Austin, TX (US); Robert Douglas Fogg, Hutto, TX (US)

(72) Inventors: Zane McCarthy, Austin, TX (US); Robert Douglas Fogg, Hutto, TX (US)

(21) Appl. No.: 14/190,738

(22) Filed: Feb. 26, 2014

(51) Int. Cl. G02B 5/128; B05B 7/14; B05D 1/02

(52) U.S. Cl. CPC G02B 5/128; B05D 1/02; B05B 7/1404

(57) ABSTRACT

Retroreflective beads may be implanted into a coating applied to a surface of machinery to increase visibility of the machinery when a light source is directed at the machinery. A method of increasing the visibility of machinery includes applying a coating to a surface of the machinery. The coating may be a coating of paint, adhesive, or other material. The method also includes spraying the coating with beads before the coating sets to implant a portion of the beads in the coating without submerging the portion of the beads in the coating.

### PRIORITY CLAIM

This application claims priority to U.S. Provisional Patent Application No. 61/769,332, filed Feb. 26, 2013, which is incorporated by reference herein in its entirety.

### FIELD OF THE DISCLOSURE

The present disclosure is generally related to improving the visibility of machinery with retroreflective beads embedded in a coating of paint on the machinery.

### BACKGROUND

Increasing the visibility of an object that is illuminated by a light source may enhance safety associated with the object by providing increased awareness of the object to a person observing the object. Roadway markings (e.g., lane markings, arrows, warning indicia, etc.), airport runway markings, signs (e.g., traffic signs, license plates, decals, etc.), clothing, and other articles may be treated with retroreflective material (e.g., retroreflective beads and retroreflective fibers) to enable a significant portion of illumination supplied by a light source (e.g., headlights of a vehicle, a flashlight, or other light source) to reflect back towards the light source in order to increase visibility. For roadways and signs, gravity feed of the retroreflective material may be utilized during application of the retroreflective material to a surface.

### SUMMARY

In an embodiment, a method of increasing the visibility of machinery includes applying a coating to a surface of the machinery. The coating may be a coating of paint, adhesive, or other material. The method also includes spraying the coating with beads before the coating sets to implant a portion of the beads in the coating without submerging the portion of the beads in the coating. The beads may be retroreflective beads. The machinery may be mobile machinery (e.g., vehicles, trailers, mining equipment, construction equipment, doors, etc.) or stationary equipment (e.g., communication equipment, electricity supply equipment, light posts, navigation markers, etc.).

In another embodiment, a system includes a paint applicator to apply a coating of paint to machinery. The system may also include a bead applicator to propel beads into the coating of paint applied to the machinery by the paint applicator before the coating of paint is dried to implant a portion of the beads in the coating without submerging the portion in the coating.

In another embodiment, machinery includes a coating of paint applied to a visible surface of the machinery. The machinery also includes a plurality of retroreflective beads implanted in the coating of paint via a compressed gas before the paint dries. The compressed gas may be air, nitrogen, or other gas. The retroreflective beads improve visibility of the machinery when a light source is directed at the coating of paint with the retroreflective beads by reflecting a portion of light back towards the light source.

### BRIEF DESCRIPTION OF THE DRAWINGS

FIG. 1 is a block diagram of an embodiment of a system to apply beads to machinery.

FIG. 2 depicts a flow chart of an embodiment of a method to apply beads to machinery to increase visibility of the machinery.

### DETAILED DESCRIPTION

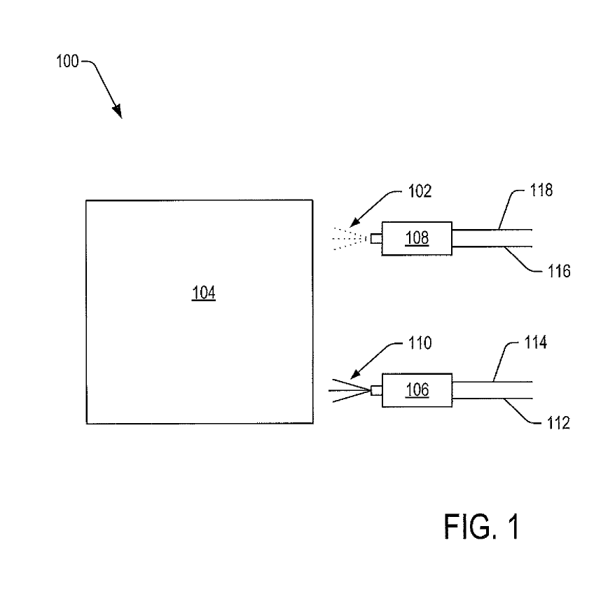

FIG. 1 is a block diagram of an embodiment of a system 100 to apply beads 102 to machinery 104. The beads 102 may be retroreflective beads that improve visibility of the machinery 104 by reflecting a portion of light received from a light source back towards the light source. The machinery 104 may be mobile machinery (e.g., vehicles, trailers, mining equipment, construction equipment, doors, etc.) or stationary equipment (communication equipment, electricity supply equipment, light posts, navigation markers, etc.). The system 100 may include a paint applicator 106 to apply paint 110 to the machinery 104 and a bead applicator 108 to embed the beads 102 in the paint 110 without submerging the beads 102 in the paint 110.

Before the paint 110 is applied to the machinery 104, a surface or surfaces of the machinery 104 that are to be painted may be treated. Treatment of the surfaces may include, but is not limited to, stripping off old paint, cleaning, masking one or more areas that are not to receive the paint 110, applying a primer, or combinations thereof. The paint 110 may be an epoxy resin paint, an enamel paint, a latex paint, an oil based paint, a water based paint, or combinations thereof.

The paint applicator 106 may be a brush, roller, sprayer, another type of applicator, or a combination thereof that applies the paint 110 to the machinery 104. In the embodiment depicted in FIG. 1, the paint applicator 106 is a sprayer. The paint applicator 106 may include a paint line 112 and a propellant line 114. The paint line 112 may be coupled to a supply of the paint 110. The paint 110 may be pumped to the paint applicator 106, may be gravity fed to the paint applicator 106, or may be drawn to the paint applicator 106 by the propellant from the propellant line 114. The propellant may be a compressed gas. The gas may be air, nitrogen, or other gas supplied to the paint applicator 106 via the propellant line 114.

Propellant from the propellant line 114 may propel paint from the paint line 112 out of the paint applicator 106 towards the machinery 104 to apply a coating of the paint 110 to the machinery 104. In some embodiments, an operator may manually use the paint applicator 106 to apply the paint 110 to the machinery 104. Manual application of the paint 110 to the machinery 104 may enhance the ability to quickly treat different types of machinery 104 with minimal preparation time to accommodate different shapes and contours of the machinery 104 to be treated by the system 100.

In other embodiments, the paint applicator 106 may be machine controlled. Machine control of the paint applicator 106 may enable control of an amount of the paint 110 used to apply a coating of the paint 110 to the machinery 104 and uniform application of the paint 110. Machine control of the paint applicator 106 may facilitate application of the beads 102 to the paint at a particular time relative to the application of the paint 110 to the machinery 104, particularly when the bead applicator 108 is also machine controlled.

After the paint 110 is applied to the machinery 104 and before the paint dries, the bead applicator 108 may be used embed a portion of the beads 102 in the coating of the paint 110. The bead applicator 108 may include a bead line 116 and a propellant line 118. The bead line 116 may be coupled to a supply of the beads 102. The beads may be substantially spherical beads with effective diameters in a range from about 25 microns to about 200 microns. The beads 110 may be pumped to the bead applicator 108, may be gravity fed to the bead applicator 108, or may be drawn to the bead applicator 108 by the propellant from the propellant line 118. The propellant may be a compressed gas. The gas may be air, nitrogen, or other gas supplied to the bead applicator 108 via the propellant line 118. In some embodiments, the propellant supplied via the propellant line 114 to the paint applicator 106 comes from the same source (e.g., a compressor) as the propellant supplied via the propellant line 118 to the bead applicator 108.

Propellant from the propellant line 118 may propel beads 102 from the bead line 116 out of the bead applicator 108 towards the machinery 104 to embed a portion of the beads in a coating of the paint 110 applied to the machinery 104. A distance of the bead applicator 108 from the machinery 104 and an output pressure of the bead applicator 108 may be controlled so that a portion of the beads 102 are implanted in the coating of the paint 110 without submergence of the beads 102 into the coating of the paint 110. Some of the beads 102 propelled from the bead applicator 108 may not embed in the coating of the paint. Such beads may be gathered and reused. Some of the beads 102 propelled from the bead applicator may submerge in the coating of the paint 110. A significant portion of the beads that are embedded in the coating without submergence may be implanted to a depth from about 30% to about 65% of an effective diameter of the beads. The significant portion may be more than 20%, more than 30%, or more than 40% of the beads 102 implanted in the coating and not submerged in the coating.

In some embodiments, an operator may manually use the bead applicator 108 to apply the beads 102 to the coating of paint. Manual application of the beads 102 to the coating of paint may enhance the ability to quickly treat different types of machinery 104 with minimal preparation time to accommodate different shapes and contours of the machinery 104 to be treated by the system 100.

In other embodiments, the bead applicator 108 may be machine controlled. Machine control of the bead applicator 108 may enable control of an amount of the beads 102 to be applied to the coating of paint and uniform dispersal of the beads 102 in the coating of paint. Machine control of the bead applicator 108 may be initiated at a precise time relative to application of the coating of the paint 110, particularly when the paint applicator 106 is also machine controlled.

After application of the beads 102, the paint may be allowed to dry to secure the beads to the machinery 104. In some embodiments, a sealant may be applied to the coating of the paint 110 with the embedded beads 102. The sealant may promote durability of the beads 102 in the coating during operation and cleaning of the machinery 104.

Machinery 104 treated by the system 100 may include a coating of paint 110 applied to a visible surface of the machinery 104. A plurality of retroreflective beads may be implanted in the coating of paint via a compressed gas before the paint dries. The retroreflective beads improve visibility of the machinery when a light source is directed at the coating of paint with the implanted retroreflective beads by reflecting a significant portion of light back towards the light source. A sealant may be applied to the coating and the beads to increase the durability of the beads in the coating.

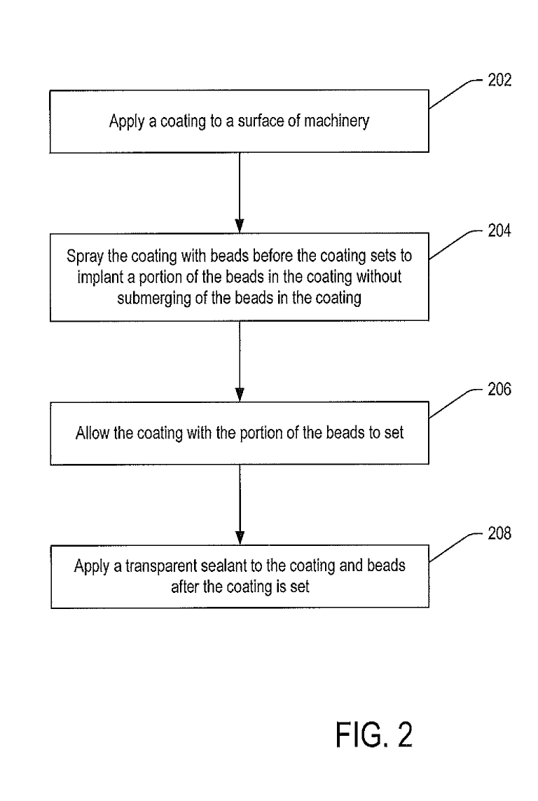

FIG. 2 is a flow chart of a particular embodiment of a method of a method to apply beads to machinery to increase visibility of the machinery. The method may be performed by the system depicted in FIG. 1. The machinery or portions of the machinery that are to be treated may be prepared for treatment. Preparing for treatment may include, but is not limited to masking portions of the machinery that are not to be treated (e.g., windows, lights, reflectors, etc.), stripping old coatings off of the surfaces to be treated, cleaning surfaces that are to be treated, applying primer to the surfaces that are to be treated, or combinations thereof. At 202, a coating may be applied to a surface of the machinery that is to be treated. The coating may be, but is not limited to paint, an adhesive, a polymeric coating (e.g., a polyurethane coating), a resin, or another type of coating. The coating may be sprayed on to the machinery, rolled onto the machinery, applied with a brush, applied via another application technique, or combinations thereof.

The coating may be sprayed with beads before the coating sets to implant a portion of the beads in the coating without submerging the portion of the beads in the coating, at 204. The beads may be propelled into the coating from a nozzle via a gas. The gas may be air, nitrogen, or another gas. The nozzle may be a component of a bead applicator. The bead applicator may be a modified sand blaster, air brush, or other machine designed to propel powders, sand, or other particulate matter. A pressure of the gas and a general distance of the nozzle from the coating may be adjustable to inhibit submergence of a significant portion of the beads exiting the nozzle in the coating. The pressure may range from about 1 psig (pounds per square inch gauge) to about 120 psig, although lower or higher pressures may also be used. The distance from the nozzle to the coating may range from about one quarter of an inch to about 30 inches, although smaller or larger distances may also be used. The nozzle may be controlled by a human operator or the nozzle may be machine controlled. A machine controlled nozzle may result in a more even distribution of the beads in the coating as compared to a human controlled nozzle.

During spraying of the coating with the beads, some beads may be submerged in the coating, and some beads may not be submerged or implanted in the coating. Beads that are not submerged or implanted in the coating may be collected and reused. A significant portion of the beads implanted in the coating are implanted in the coating to a depth from about 30% to about 65% of an effective diameter of the beads. The significant portion may be over 20%, over 30%, or over 40% of the beads implanted but not submerged in the coating. Effective diameters of the beads may be between 25 microns and 200 microns, although beads with smaller or larger effective diameters may also be used.

After application of the beads, the coating may be allowed to set, at 206. The coating may be set by air drying, by convection, by application of heat, by application of a curing agent, by application of another type of compound, or by combinations thereof. When the coating sets, the beads implanted in the coating may be secured to the machinery. A significant portion of light directed at the machinery from a light source may be directed back towards the light source enabling increased visibility of the machinery in low light conditions to a viewer of the machinery between the light source and the machinery and substantially aligned with the light source, to a viewer near to the light source (e.g., in a cab of a vehicle when the light source is headlights of the vehicle), and to a viewer behind the light source and substantially aligned with the light source.

A sealant may be applied to the coating and beads after the coating is set, at 208. The sealant may be sprayed on, rolled, on, brushed on, applied via another technique, or applied by combinations thereof. The sealant may be transparent when dry. In some embodiments, a sealant is not used.

Although the description above contains many specificities, these specificities are utilized to illustrate some of the exemplary embodiments of this disclosure and should not be construed as limiting the scope of the disclosure. The scope of this disclosure should be determined by the claims, their legal equivalents and the fact that it fully encompasses other embodiments which may become apparent to those skilled in the art. A method or device does not have to address each and every problem to be encompassed by the present disclosure. All structural, chemical and functional equivalents to the elements of the disclosure that are known to those of ordinary skill in the art are expressly incorporated herein by reference and are intended to be encompassed by the present claims. A reference to an element in the singular is not intended to mean one and only one, unless explicitly so stated, but rather it should be construed to mean at least one.

The disclosure is described above with reference to drawings. The drawings may not be to scale. The drawings illustrate certain details of specific embodiments that implement the systems and methods of the present disclosure. However, describing the disclosure with drawings should not be construed as imposing on the disclosure any limitations that may be present in the drawings.

It should be noted that although the flowcharts provided herein show a specific order of method steps, it is understood that the order of these steps may differ from what is depicted. Also two or more steps may be performed concurrently or with partial concurrence.

The foregoing description has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, method steps may be performed in a different order than is shown in the figures or one or more method steps may be omitted. Accordingly, the disclosure and the figures are to be regarded as illustrative rather than restrictive.

Moreover, although specific embodiments have been illustrated and described herein, it should be appreciated that any subsequent arrangement designed to achieve the same or similar results may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the claimed subject matter may be directed to less than all of the features of any of the disclosed embodiments.

What is claimed is:

1. A method of increasing visibility of machinery, comprising:
applying a coating to a surface of the machinery; and
spraying the coating with beads before the coating sets to implant a portion of the beads in the coating without submerging the portion of the beads in the coating.

2. The method of claim 1, wherein spraying the beads comprises propelling the beads into the coating from a nozzle via compressed air.

3. The method of claim 2, wherein a pressure of the compressed air and a general distance of the nozzle from the coating are adjustable to inhibit submergence of the beads in the coating.

4. The method of claim 3, wherein the pressure of the compressed air is from about 10 psig to about 120 psig.

5. The method of claim 3, wherein the general distance is from about one half inch to about 30 inches.

6. The method of claim 1, wherein the beads comprise retroreflective beads.

7. The method of claim 6, wherein an index of refraction of the beads is between about 1.3 and about 2.4.

8. The method of claim 1, wherein the coating comprises a coating of adhesive.

9. The method of claim 1, wherein a significant portion of the beads implanted in the coating are implanted in the coating to a depth from about 30% to about 65% of an effective diameter of the beads.

10. The method of claim 1, wherein an effective diameter of the beads is between 25 microns and 200 microns.

11. A system comprising:
a paint applicator to apply a coating of paint to machinery; and
a bead applicator to propel beads into the coating of paint applied to the machinery by the paint applicator before the coating of paint is dried to implant a portion of the beads in the coating without submerging the portion in the coating.

12. The system of claim 11, further comprising a coating applicator to apply a sealant to the coating and the beads implanted in the coating.

13. The system of claim 11, wherein the paint applicator is machine controlled so that a thickness of the coating is substantially uniform.

14. The system of claim 11, wherein the bead applicator is machine controlled to substantially evenly distribute the beads in the coating.

15. The system of claim 11, wherein the beads are retroreflective beads.

16. The system of claim 11, wherein the paint is an epoxy resin paint.

17. The system of claim 11, wherein the bead applicator propels the beads via a compressed gas.

18. Machinery comprising:
a coating of paint applied to a visible surface of the machinery; and
a plurality of retroreflective beads implanted in the coating of paint via a compressed gas before the paint dries, wherein the retroreflective beads improve visibility of the machinery when a light source is directed at the coating of paint with the retroreflective beads by reflecting a significant portion of light back towards the light source.

19. The machinery of claim 18, wherein the machinery is a vehicle.

20. The machinery of claim 18, further comprising a sealant applied to the coating of paint with the retroreflective beads.
